(19) United States
(12) Patent Application Publication
(10) Pub. No.: US 2008/0005159 A1
(43) Pub. Date: Jan. 3, 2008

(54) METHOD AND COMPUTER PROGRAM PRODUCT FOR COLLECTION-BASED ITERATIVE REFINEMENT OF SEMANTIC ASSOCIATIONS ACCORDING TO GRANULARITY

(75) Inventors: Feng Kang, Okemos, MI (US); Milind R. Naphade, Fishkill, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/427,101

(22) Filed: Jun. 28, 2006

(51) Int. Cl. G06F 17/00

(52) U.S. Cl. 707/103 R

(57) ABSTRACT

A computer implemented method and computer program product for automatically building semantic associations within a database of unstructured information includes an algorithm for mapping data within the unstructured information and iteratively improving semantic labels for association with the data, until such point as associations pass a convergence test and then the semantic associations are made.

### STATEMENT REGARDING FEDERALLY SPONSORED RESEARCH

This invention was developed with Government support under U.S. Government Contract No. 2004*H839800*000 awarded by the Advanced Research and Development Activity (ARDA) of the U.S. Department of Defense. The Government has certain rights in this invention.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The teachings herein relate to systems for managing unstructured information having varying granularity.

2. Description of the Related Art

In the art of unstructured information processing, associating annotations with an appropriate granularity is a time consuming and expensive process. Typically, most of the meta-data, annotations and tags are provided at a granularity level that is more coarse than is appropriate. Propagating annotations of a coarse grain to an appropriate fine grain is a challenge for a variety of reasons. If higher quality annotation is made available for information having finer granularity, the models that are derived from this finer-grain association are much better in terms of performance

Unfortunately, no solutions are currently available that provide for automating the association of annotations and that iteratively improve the quality of the tagging (provide for improvements in matching the level of granularity). Although some efforts have been successful for one-time processing and tagging of labels provided at coarse granularities to finer granularities, this work fails to address the opportunity and performance enhancement made possible by smart iterative processing.

What is needed is a technique for automating the association of semantic labels with unstructured information where the association proceeds at an appropriate granularity. Preferably, the technique provides for iterative improvements referred to as “smart processing.”

### SUMMARY OF THE INVENTION

The shortcomings of the prior art are overcome and additional advantages are provided through the provision of a computer implemented method for making semantic associations in unstructured information, the method including: selecting a database of unstructured information, the unstructured information including a series of records; iteratively learning a model for generating a first map of aspects of the unstructured information using an algorithm for characterizing the unstructured information; applying the model to select a subset of records in the unstructured information and learning at least another model for generating at least another map of aspects of the unstructured information; testing for a convergence between the first map and the at least another map and continuing with the learning, the applying and the testing until a convergence is reached; and producing a final combined mapping from which semantic labels are associated with the unstructured information.

Also disclosed is a computer program product stored on machine readable media and including instructions for making semantic associations in unstructured information, the instructions for: selecting a database of unstructured information, the unstructured information including a series of records; iteratively learning a model for generating a first map of aspects of the unstructured information using an algorithm for characterizing the unstructured information; applying the model to select a subset of records in the unstructured information and learning at least another model for generating at least another map of aspects of the unstructured information; testing for a convergence between the first map and the at least another map and continuing with the learning, the applying and the testing until a convergence is reached; and producing a final combined mapping from which semantic labels are associated with the unstructured information.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which in a computer program product stored on machine readable media and including instructions for making semantic associations in unstructured information, the instructions for: selecting a database of unstructured information, the unstructured information having a series of records; iteratively learning a model for generating a first map of aspects of the unstructured information using an algorithm for characterizing the unstructured information, wherein characterizing includes smart sampling of selected artifact-annotation associations for building artifact-annotation association models; applying the model to select a subset of records in the unstructured information and learning at least another model for generating at least another map of aspects of the unstructured information, wherein the at least another model includes at least one intermediate model of annotations based on coarse annotations and fine-grained artifact characteristics, wherein automatic attribution of annotations for finer grained artifacts is based on the intermediate models and smart selection of most likely artifact-annotation associations including finer granularity is based on the intermediate models and the automatic attribution; testing for a convergence between the first map and the at least another map and continuing with the learning, the applying and the testing until a convergence is reached; and producing a final combined mapping from which semantic labels are associated with the unstructured information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates exemplary components of a computer system suited for practicing the teachings herein;

FIG. 2 illustrates aspects of unstructured information in a data stream;

FIG. 3 depicts aspects of a process for iterative refinement of annotations.

The detailed description explains the preferred embodiments of the invention, together with advantages and features, by way of example with reference to the drawings.

### DETAILED DESCRIPTION OF THE INVENTION

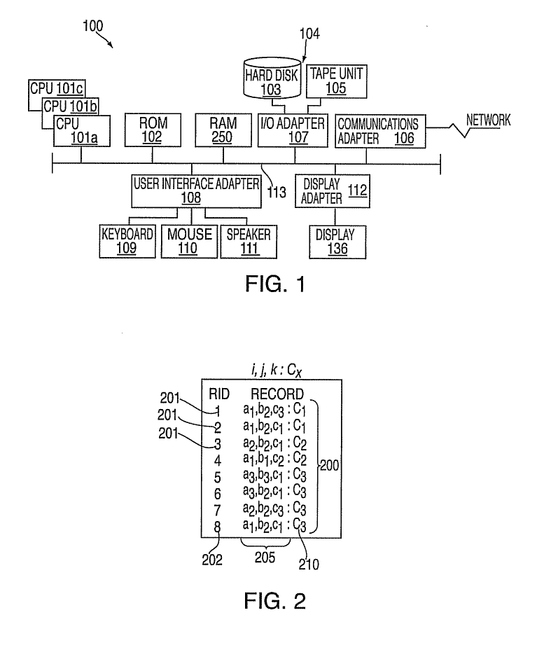

Referring now to FIG. 1, an embodiment of a data processing system 100 according to the present invention is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI) bus. Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

Referring to FIG. 2, unstructured information 200, as presented herein, includes a series of records 201. Each record 201 typically includes various information fields 205. Each record 201 may further include a record identifier 202 and some other label 210. The record identifier 202 is typically an index indicating a record number in the series, while the label 210 may be determined by some other means, such as by an algorithm following an evaluation of the content for the various information fields 205 of the respective record 201.

Prior art models generally do not adapt to changes in the character of data within the data stream (the unstructured information 200), and can be considered to exhibit a higher degree of “granularity” (i.e., specificity or generality) than is typically desired.

Manually associating semantic labels 210 using an appropriate granularity in unstructured information 200 is a labor intensive and time intensive task. This is particularly the case where one is faced with large collections of unstructured information 200.

No solutions are presently known to the inventors that provide for automating association of labels 210 and that also provide for iterative improvements in the granularity of the association (or “tagging”). Although some techniques have provided for one-time processing and tagging of labels 210 from coarse granularities to finer granularities, these techniques fail to capitalize on opportunities made possible by smart iterative processing.

The teachings herein address the above problem by providing for iterative processing wherein cross-collection statistics are used to determine an appropriate information granularity for the semantic label 210 at every iteration. Sampling techniques are used for to iterative application of the optimization and result in improvements in the selection accuracy for each label 210.

Although the term “semantic” is used herein to generally connote aspects of data stream within a set of unstructured information 200, semantics are not limited to certain forms of data (such as alphanumeric presentations) or the content of the data. Rather, the term “semantics” generally males reference to any type and any form of data presented in the unstructured information 200.

The teachings herein call for an iterative technique wherein each record 210, or certain selected records 210 (such as, for example, a statistically significant number of records 210) of the unstructured information 200 is processed. Processing involves at least one of sampling, evaluating and analyzing aspects of each record 201, or selected records 201. For example, sampling may call for ascertaining a value for a selected field 205 from selected records 201. Evaluating the record 201 may call for determining if a certain condition is present (such as the selected information field 205 includes a certain value). Analyzing may include other techniques, such as performing group statistics on certain aspects of a group of the selected records 201. In short, a variety of techniques for qualifying or characterizing the unstructured information 200 may be employed.

As discussed herein, an algorithm (including machine readable instructions stored on machine readable media) provides for the automated and iterative technique. With each iteration, an intermediate mapping from the coarse granularity to the finer granularity is developed using cross-collection statistics and learning from the iteration. Results from each mapping are used to develop a model.

The algorithm selects from each model an artifact with a coarse-grain label 210 and multiple finer grain labels 210 (or sub-granular artifacts). The algorithm uses a variable number of the sub-granular artifacts and assumes this mapping to be accurate. The variably selected artifacts are then used in another iteration of the algorithm. In the next iteration, the algorithm again processes the unstructured information 200 and provides another mapping of the unstructured information 200.

The next iteration revises the mapping by learning a revised model of the mapping. Each iteration provides a refined model in comparison to the prior model. These iterations are repeated until a disagreement between mapping models from consecutive iterations drop below a predetermined threshold.

Once a satisfactory granularity has been achieved, the algorithm then proceeds to use one or more of the mapping models created during each iteration to create a final combined mapping from the coarse granularity to the finer granularity artifacts and propagates the coarse-grain semantic labels 210 to the finer-grain artifacts.

These labels 210 can then be used to train conventional models of single-instance artifacts and their associated labels 210 for further re-use on un-annotated artifact collections.

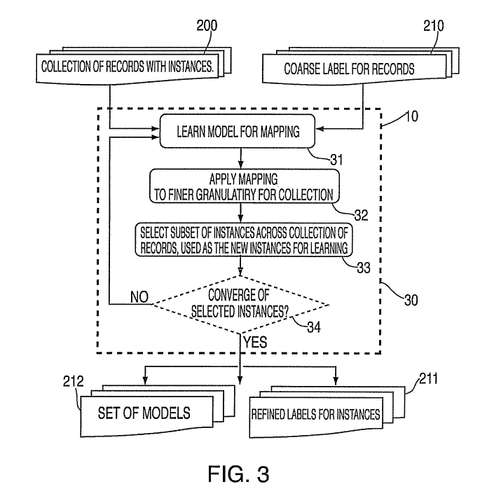

Referring to FIG. 3, the algorithm 10 provides for iterative processing 30. Iterative processing 30, in this embodiment, involves learning a model for mapping 31 the unstructured information 200; applying the mapping 32; learning a new model 33 from the new instances for learning and testing convergence 34. Iterative processing 30 produces a set of models 212 and a set of refined labels 211.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method for making semantic associations in unstructured information, the method comprising:
selecting a database of unstructured information, the unstructured information comprising a series of records;
iteratively learning a model for generating a first map of aspects of the unstructured information using an algorithm for characterizing the unstructured information;
applying the model to select a subset of records in the unstructured information and learning at least another model for generating at least another map of aspects of the unstructured information;
testing for a convergence between the first map and the at least another map and continuing with the learning, the applying and the testing until a convergence is reached; and
producing a final combined mapping from which semantic labels are associated with the unstructured information.

2. The method as in claim 1, further comprising: smart sampling of selected artifact-annotation associations for building artifact-annotation association models.

3. The method as in claim 1, further comprising: creating intermediate models of annotations based on coarse annotations and fine-grained artifact characteristics.

4. The method as in claim 3, further comprising automatically attributing annotations for finer grained artifacts based on the intermediate models.

5. The method as in claim 4, further comprising selection of most likely artifact-annotation associations comprising finer granularity based on the intermediate models and the automatic attribution.

6. A computer program product stored on machine readable media and comprising instructions for making semantic associations in unstructured information, the instructions comprising instructions for:
selecting a database of unstructured information, the unstructured information comprising a series of records;
iteratively learning a model for generating a first map of aspects of the unstructured information using an algorithm for characterizing the unstructured information;
applying the model to select a subset of records in the unstructured information and learning at least another model for generating at least another map of aspects of the unstructured information;
testing for a convergence between the first map and the at least another map and continuing with the learning, the applying and the testing until a convergence is reached; and
producing a final combined mapping from which semantic labels are associated with the unstructured information.

7. The product as in claim 6, further comprising: sampling of selected artifact-annotation associations for building artifact-annotation association models.

8. The product as in claim 6, further comprising: creating intermediate models of annotations based on coarse annotations and fine-grained artifact characteristics.

9. The product as in claim 8, further comprising instructions for: automatically attributing annotations for finer grained artifacts based on the intermediate models.

10. The product as in claim 9, further comprising instructions for: smart selection of most likely artifact-annotation associations comprising finer granularity based on the intermediate models and the automatic attribution.

11. A computer program product stored on machine readable media and comprising instructions for making semantic associations in unstructured information, the instructions comprising instructions for:
selecting a database of unstructured information, the unstructured information comprising a series of records;
iteratively learning a model for generating a first map of aspects of the unstructured information using an algorithm for characterizing the unstructured information, wherein characterizing comprises smart sampling of selected artifact-annotation associations for building artifact-annotation association models;
applying the model to select a subset of records in the unstructured information and learning at least another model for generating at least another map of aspects of the unstructured information, wherein the at least another model comprises at least one intermediate model of annotations based on coarse annotations and fine-grained artifact characteristics, wherein automatic attribution of annotations for finer grained artifacts is based on the intermediate models and selection of most likely artifact-annotation associations comprising finer granularity is based on the intermediate models and the automatic attribution;
testing for a convergence between the first map and the at least another map and continuing with the learning, the applying and the testing until a convergence is reached; and
producing a final combined mapping from which semantic labels are associated with the unstructured information.
